(19) United States
(12) Patent Application Publication
(10) Pub. No.: US 2011/0055292 A1
(43) Pub. Date: Mar. 3, 2011

(54) SYSTEM AND METHOD FOR STANDARDIZING VEHICLE NETWORK DATA ACROSS VEHICLE PRODUCT LINES

(76) Inventors: Dinu Petre Madau, Canton, MI (US); Matthew Mark Mikolajczak, Novi, MI (US)

(21) Appl. No.: 12/553,307

(22) Filed: Sep. 3, 2009

(51) Int. Cl. G06F 15/16; G06F 17/30

(52) U.S. Cl. 707/809; 709/246; 707/E17.014

(57) ABSTRACT

A gateway system includes a vehicle network having a network data, a processor for extracting the network data from the vehicle network and converting the network data into a standardized data having an open source format, and a broadcaster in communication with the processor to receive the standardized data and transmit the standardized data to a user device, wherein the user device for use thereby.

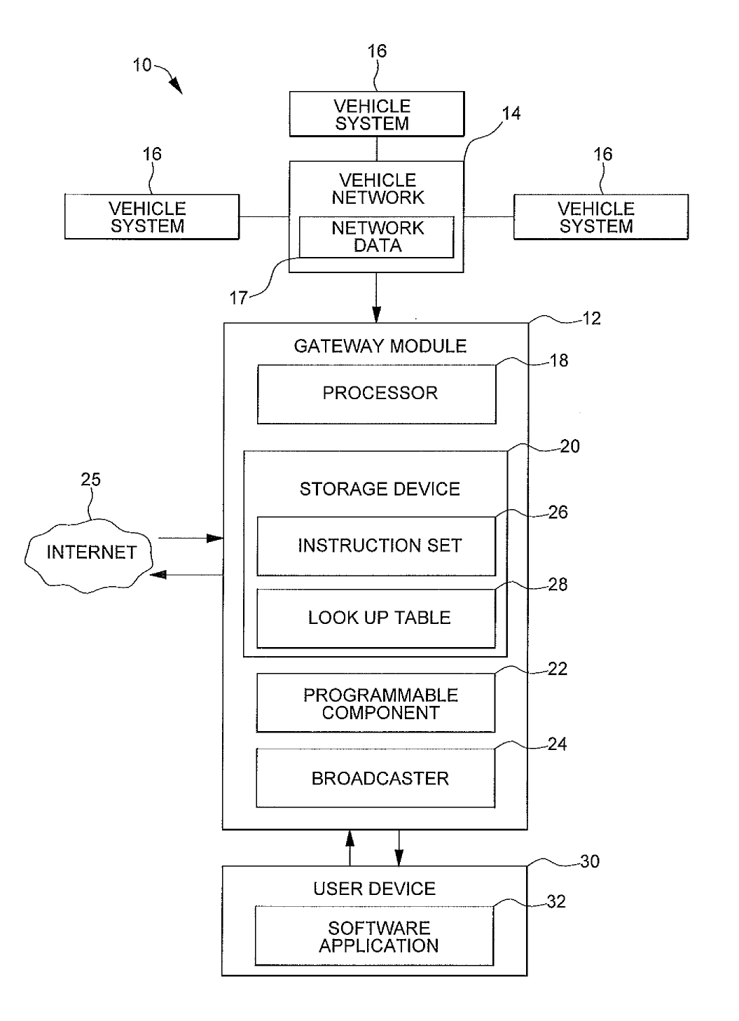

### FIELD OF THE INVENTION

The present invention relates generally to a vehicle network. More particularly, the invention is directed to a gateway system and method for standardizing data across various vehicle networks.

### BACKGROUND OF THE INVENTION

Currently, vehicles use a network to communicate information about the status and operation of the vehicle. A typical network in cars today is the Controller Area Network or “CAN”. A data that is shared by the network is intended to be consumed by other systems on the network or by external diagnostic systems specially configured to communicate with the vehicle network. However, the network data is not available for consumption by consumer electronic devices that are owned by drivers/passengers and brought into the vehicle.

One solution requires a user to know a protocol of the vehicle network and a format of the data on the network, and thereby modify a user system to interpret the network data correctly. However, this solution requires a modification to the user system for each vehicle having a different format or vehicle network protocol. For example, a navigation system requiring vehicle speed from the network would require a custom data interpreter for each vehicle line.

It would be desirable to develop a gateway system and method of standardizing a data on a vehicle network, wherein the gateway system and method provide a standardized, vehicle independent data to a user over various vehicle lines.

### SUMMARY OF THE INVENTION

Concordant and consistent with the present invention, a gateway system and method of standardizing a data on a vehicle network, wherein the gateway system and method provide a standardized, vehicle independent data to a user over various vehicle lines, has surprisingly been discovered.

In one embodiment, a gateway system comprises: a vehicle network having a network data; a processor for extracting the network data from the vehicle network and converting the network data into a standardized data having an open source format; and a broadcaster in communication with the processor to receive the standardized data and transmit the standardized data to a user device for use thereby.

In another embodiment, a gateway system comprises: a vehicle network having a network data; and a processor in uni-directional communication with the vehicle network to extract the network data from the vehicle network and convert the network data into a standardized data having a vehicle independent format; and a broadcaster in communication with the processor to receive the standardized data and transmit the standardized data to a user device, wherein the user device is interconnected with the gateway module for bi-directional data communication.

The invention also provides methods for standardizing data on a vehicle network.

One method comprises the steps of: providing a vehicle network having a network data; extracting the network data; converting the network data into a standardized data having a vehicle independent format; and providing a programmable interface to receive the standardized data and generate a feedback based upon the standardized data.

### BRIEF DESCRIPTION OF THE DRAWINGS

The above, as well as other advantages of the present invention, will become readily apparent to those skilled in the art from the following detailed description of the preferred embodiment when considered in the light of the accompanying drawing, which is a schematic block diagram of a gateway system according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

The drawing illustrates a gateway system 10 according to an embodiment of the present invention. The gateway system 10 includes a gateway module 12 in data communication with a vehicle network 14. As shown, the vehicle network 14 interconnects a plurality of vehicle systems 16 and communicates a network data 17 therebetween. It is understood that the vehicle systems 16 may be any system adapted to communicate with the vehicle network 14 such as a speedometer, a global positioning system, an engine control unit (ECU), a transmission control unit (TCU), an anti-lock braking system (ABS), a body control modules (BCM), and other electronic module, for example. As a non-limiting example, the vehicle network 14 is a Controller Area Network or “CAN”. However, other networks and protocols may be used such as a vehicle area network, a FlexRay™ network, a local interconnect network, a J1939 network, a media oriented systems transport, a domestic digital bus, Ethernet, EthernetAVB, J1394 and a DC-BUS, for example.

As shown, the gateway module 12 includes a processor 18, a storage device 20, a programmable component 22, and a broadcaster 24. The gateway module 12 may include additional components such as a communication port (not shown) for sending and receiving data via a plurality of hard-wire and wireless protocols, for example. In certain embodiments, the gateway module 12 has the ability to connect to the Internet 25.

The processor 18 is adapted to extract data from the vehicle network 14 and process the extracted data based upon an instruction set 26. The instruction set 26, which may be embodied within any computer readable medium, includes processor executable instructions for configuring the processor 18 to perform a variety of tasks. In certain embodiments, the instruction set 26 configures the processor 18 to analyze, convert, and standardize the extracted data into a pre-determined, vehicle independent data language or protocol. As a non-limiting example, the data format may be an open-source format known to those skilled in the art of software development. It is understood that any data passing through the vehicle network 14 may be extracted by the processor 18. As a non-limiting example, the extracted data includes a vehicle message having message identification, a sender information, a message type, a message length, and a signal list. As a further example, the extracted data includes a network signal information such as the type, byte ordering, size, and scaling values to translate the signal information from a raw value to a physical value.

The storage device 20 may be a single storage device or may be multiple storage devices. Portions of the storage device 20 may also be located on the processor 18. Furthermore, the storage device 20 may be a solid state storage system, a magnetic storage system, an optical storage system or any other suitable storage system. It is understood that the storage device 20 is adapted to store the instruction set 26. Other data and information may be stored in the storage device 20 such as the data extracted from the vehicle network 14. A vehicle network look-up table 28 is also stored in reprogrammable memory of the storage device 20. The look-up table 28 contains a catalog and mapping of specific network protocols associated with various vehicle lines and manufactures. It is understood that reprogramming the look-up table 28 modifies the processor 18 in order to provide compatibility between the gateway module 12 and the protocol used by the vehicle network 14. It is further understood that the look-up table 28 is referenced for converting the extracted data to a standardized, vehicle independent format.

The programmable component 22 is in communication with the processor 18. It is understood that the programmable component 22 may be in communication with any other component such as the instruction set 26 and the storage device 20, for example. In certain embodiments, the programmable component 22 is adapted to manage and control processing functions of the processor 18. Specifically, the programmable component 22 is adapted to control the analysis of the data extracted from the vehicle network 14. It is understood that the programmable component 22 may be adapted to store data and information on the storage device 20 and retrieve data and information from the storage system 18. Where the gateway module 12 includes the programmable component 22, the analysis and standardization of the extracted data by the processor 18 may be pre-programmed. It is understood that the configuration and functions of the processor 18 may be adjusted in real-time or pre-programmed by the original equipment manufacturer (OEM) or user. It is further understood that the functions of the processor 18 may have stored settings that may be recalled and processed, as desired.

The broadcaster 24 provides data intercommunication between the gateway module 12 and a user device 30 or programmable interface. It is understood that the user device may be any electronic device for storing and/or executing As a non-limiting example, the broadcaster 24 is a human machine interface having a hard-wire or wireless protocol for communication with the user device 30. As a further example, the broadcaster 24 publishes the standardized vehicle data using a pre-determined non-proprietary protocol.

In use, the gateway module 12 extracts data from the vehicle network 14. The processor 18 analyzes the data in order to properly convert the data into a standardized format having a pre-determined, vehicle independent protocol and data language. As a non-limiting example, the extracted data may include vehicle identification information that can be compared to the look-up table 28 to determine vehicle specific information such as a vehicle network protocol, a default messaging used by the vehicle network, a list of available options and accessories associated with the vehicle, and a vehicle make, model, and trim. In certain embodiments, the vehicle information is used in conjunction with a message identification extracted from the vehicle network 14 to properly classify and convert the extracted data for standardization.

Once converted, the standardized data is made available to a user. As a non-limiting example, the user device 30 receives the standardized data for use by an on-board software application 32. The user device 30 connects to the vehicle via wired or wireless communication means and begins receiving the standardized data from the gateway module 12 necessary to execute the applets on the user device 30. As a non-limiting example, a portable vehicle navigation system that normally loses GPS satellite lock can use vehicle speed information extracted from the vehicle network 14 for dead reckoning.

A user can also download applets directly to the gateway module 12 through an HMI gateway or other connectivity, wherein the downloaded applet can run on demand. For example, a tour guide applet may be downloaded to receive a vehicle information from the vehicle network 14 such as GPS location and a vehicle speed in order to provide an accurate feedback to the user. It is understood that the standardized nature of the extracted data facilitates third party developers in creating any number of applets and software applications, both to entertain and to inform. It is further understood that the gateway module 12 may be removed from the vehicle, whereby the standardized vehicle data may be extracted and analyzed to determine vehicle conditions and performance, analogous to a “black box” used in aircraft.

The gateway module 12 of the present invention publishes vehicle data in a known standardized format that is consistent across multiple vehicle car lines. No special importing processes are required to make use of the extracted data. The gateway module 12 provides a means to extract vehicle data that can enhance applications in consumer electronic devices as well as provide a foundation for new applications that have not been consider due to the lack of vehicle data available.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A gateway system comprising:
a vehicle network having a network data;
a processor for extracting the network data from the vehicle network and converting the network data into a standardized data having an open source format; and
a broadcaster in communication with the processor to receive the standardized data and transmit the standardized data to a user device for use thereby.

2. The gateway system according to claim 1, wherein the broadcaster transmits the standardized data using at least one of a universal serial bus, a wireless protocol, a fire wire, and a radio signal.

3. The gateway system according to claim 1, further comprising a look-up table in communication with the processor, the look-up table having a catalog and a mapping of specific network protocols associated with various vehicle lines and manufacturers.

4. The gateway system according to claim 3, wherein the converting of the network data into the standardized data is accomplished by using information in the look-up table.

5. The gateway system according to claim 1, further comprising a storage device in data communication with the processor and adapted to store a software application for receiving the standardized data and providing a feedback based upon the standardized data.

6. The gateway system according to claim 1, further comprising a programmable component in data communication with the processor.

7. A gateway system comprising:
a vehicle network having a network data; and
a processor in uni-directional communication with the vehicle network to extract the network data from the vehicle network and convert the network data into a standardized data having a vehicle independent format; and
a broadcaster in communication with the processor to receive the standardized data and transmit the standardized data to a user device, wherein the user device is interconnected with the gateway module for bi-directional data communication.

8. The gateway system according to claim 7, wherein the broadcaster transmits the standardized data using at least one of a universal serial bus, a wireless protocol, a fire wire, and a radio signal.

9. The gateway system according to claim 7, further comprising a look-up table in communication with the processor, the look-up table having a catalog and a mapping of specific network protocols associated with various vehicle lines and manufacturers.

10. The gateway system according to claim 9, wherein the converting of the network data into the standardized data is accomplished by using information in the look-up table.

11. The gateway system according to claim 7, further comprising a storage device in data communication with the processor and adapted to store a software application for receiving the standardized data and providing a feedback based upon the standardized data.

12. The gateway system according to claim 7, wherein the user device includes a software application for receiving the standardized data and providing a feedback based upon the standardized data.

13. The gateway system according to claim 12, wherein the software application is an open source applet.

14. The gateway system according to claim 7, wherein the vehicle independent format is an open source data format.

15. The gateway system according to claim 7, wherein the processor is interconnected to the Internet.

16. A method for standardizing data on a vehicle network, the method comprising the steps of:
providing a vehicle network having a network data;
extracting the network data;
converting the network data into a standardized data having a vehicle independent format; and
providing a programmable interface to receive the standardized data and generate a feedback based upon the standardized data.

17. The method according to claim 16, wherein the converting of the network data into the standardized data is accomplished by using information in the look-up table.

18. The method according to claim 16, wherein the programmable interface includes a software application to generate the feedback.

19. The method according to claim 16, wherein the vehicle independent format is an open source data format.

20. The method according to claim 16, wherein the programmable interface includes an open source applet to generate the feedback.
